(19) United States
(12) Patent Application Publication
(10) Pub. No.: US 2007/0268383 A1
(43) Pub. Date: Nov. 22, 2007

(54) Imaging Optical Instrument, Captured Image Processing System, and Captured Image Processing Program

(75) Inventors: Kyoichi Miyazaki, Osaka (JP); Kenichi Honjo, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Osaka (JP)

(21) Appl. No.: 11/570,019

(22) PCT Filed: Aug. 22, 2005
(86) PCT No.: PCT/JP05/15217

§ 371 Date: Dec. 4, 2006

(30) Foreign Application Priority Data
Aug. 25, 2004 (JP) 2004-245671

(51) Int. Cl. H04N 5/76

(52) U.S. Cl. 348/231.99; 348/E05.024

(57) ABSTRACT

An imaging optical instrument 12 includes: an imaging optical system 1; an imaging element 2; an image shift unit 3 for working on at least one of the imaging optical system 1 and the imaging element 2 so as to shift a position of a subject image with respect to the imaging element 2; an image storage unit 4 for storing a plurality of sets of image data; a harmful luminance image detection unit 5; and an image correction unit 6. The harmful luminance image detection unit 5 includes: an image shift arithmetic unit 8 for making the positions of the subject image of the plurality of sets of image data coincide with one another; and a differential image arithmetic unit 9 for carrying out differential arithmetic processing with respect to the sets of image data with the positions of the subject image having been made to coincide with one another, so as to detect a set of harmful luminance image data from sets of harmful luminance image data obtained in relation to the plurality of sets of image data. The image correction unit 6 uses the detected set of harmful luminance image data and corrects the image data corresponding to the detected set of harmful luminance image data, so as to obtain a correction-completed image. This configuration allows the imaging optical instrument to be capable of preventing the image quality of a captured image from being deteriorated by dust or a scratch in the imaging optical system.

### TECHNICAL FIELD

The present invention relates to an imaging optical instrument for imaging a digital image, a captured image processing system, and a captured image processing program. The present invention particularly relates to an imaging optical instrument, a captured image processing system, and a captured image processing program that are capable of improving image quality by correcting captured images.

### BACKGROUND ART

Recently, remarkable improvement has been made in the quality of images captured by an imaging optical instrument, particularly a digital still camera (hereinafter referred to as DSC) and a digital video camera (hereinafter referred to as DVC). For instance, a device has been developed that performs a decentering driving control with respect to a lens, a charge coupled device (CCD), or the like so as to correct a movement of a subject caused by vibration of an imaging optical instrument (camera shake). With use of this, an imaging optical instrument that records a digital image with more than eight million pixels has been brought to market. Further, the performance of an imaging optical system for use in an imaging optical instrument has been improved also, and for instance, a high-performance lens has been developed in which an anomalous dispersion glass material, an aspherical lens, or the like is used.

The following describes a conventional imaging optical instrument by referring to FIGS. 14 to 16. The conventional imaging optical instrument is a imaging optical instrument with a camera shake correction function, which includes a movement correcting unit. FIG. 14 is a block diagram illustrating an example of a configuration of a first conventional imaging optical instrument. FIG. 15 is a block diagram illustrating an example of a configuration of a second conventional d imaging optical instrument. Still further, FIG. 16 is a block diagram illustrating an example of a configuration of a third conventional imaging optical instrument.

To begin with, a first conventional imaging optical instrument 212 is described. The first conventional imaging optical instrument 212 is configured as shown in FIG. 14. When along an imaging optical axis 214 light from a subject enters an imaging optical system 201 having a plurality of lenses, the imaging optical system 201 forms a subject image on an imaging element 202. The imaging element 202 generates digital image data according to the subject image. The image data are stored in an image storage unit 204.

A movement correction unit 223 is capable of working on the imaging optical system 201 so as to shift the position of the subject image on the imaging element 202 in a direction substantially perpendicular to the imaging optical axis 214. More specifically, by shifting at least one lens of the imaging optical system 201, the position of the subject image on the imaging element 202 can be shifted. The imaging optical instrument 212 includes a movement detection unit 207 for detecting a movement of a main body of the imaging optical instrument 212. The movement detection unit 207 detects movement data representing a movement of the main body of the imaging optical instrument 212, such as a direction and an amount of a movement. In the case where the main body of the imaging optical instrument 212 is moved due to camera shake or the like, the position of the subject image on the imaging element 202 is shifted. Then, the movement correction unit 223 shifts the position of the subject image in a direction substantially perpendicular to the imaging optical axis 214 so as to correct the shift of the position of the subject image, whereby the position of the subject image with respect to the imaging element 202 is not shifted actually. By so doing, even with camera shake or the like, the subject image is formed at the same position on the imaging element 202, thereby making it possible to prevent the image quality of the captured image from being deteriorated by camera shake.

Next, a second conventional imaging optical instrument 312 is described with reference to FIG. 15. It should be noted that in FIG. 15, the members having the same functions as those shown in FIG. 14 are designated with the same reference numerals, and descriptions of the same are omitted. As shown in FIG. 15, a movement correction unit 323 of the imaging optical instrument 312 is intended to shift the position of the imaging element 202 in a direction substantially perpendicular to the imaging optical axis 214. This causes a position of a subject image on the imaging element 202 to shift in a direction substantially perpendicular to the imaging optical axis 214. The movement correction unit 323 of the second conventional imaging optical instrument 312 shifts the imaging element 202 in a direction substantially perpendicular to the imaging optical axis 214 based on movement data detected by the movement detection unit 207 so that the position of the subject image is not shifted with respect to the imaging element 202 by camera shake or the like. By so doing, even if the imaging optical instrument 312 moves due to camera shake or the like, the subject image is formed at the same position on the imaging element 202. Therefore, it is possible to prevent the image quality of the captured image from being deteriorated by camera shake.

Next, a third conventional imaging optical instrument 412 is described with reference to FIG. 16. It should be noted that in FIG. 16, the members having the same functions as those shown in FIG. 14 are denoted with the same reference numerals, and descriptions of the same are omitted. As shown in FIG. 16, a movement correction unit 423 of the imaging optical instrument 412 performs movement correction by shifting the imaging optical system 201 and the imaging element 202. More specifically, the movement correction unit 423 rotates the imaging optical system 201 and the imaging element 202 around a rotational axis 422 as the center, which is an axis perpendicular to the imaging optical axis 214. This causes a position of a subject image on the imaging element 202 to be shifted in a direction substantially perpendicular to the imaging optical axis 214. The movement correction unit 423 of the third conventional imaging optical instrument 412 rotates the imaging optical system 201 and the imaging element 202 around the rotational axis 422 as the center based on the movement data detected by the movement detection unit 207 so that an image forming position of a subject image should not be shifted with respect to the imaging element 202. By so doing, even with camera shake or the like, the subject image is formed at the same position on the imaging element 202. Therefore, it is possible to prevent the image quality of the captured image from being deteriorated by camera shake or the like.

As described above, sufficient camera shake correction is performed by shifting the position of the subject image on the imaging element 202 in a direction substantially perpendicular to the imaging optical axis 214.

On the other hand, there also has been a problem that image quality is deteriorated by dust entering or adhering to an optical system in the vicinity of a light-receiving surface of an imaging element, or a scratch made on an optical system. This is a serious problem for an imaging optical instrument such as the DSC or the DVC, in which enhancement of the quality of an image because of enhancement of image performance of an imaging optical system and enhancement of performance of an imaging element, and downsizing are promoted. To avoid the foregoing problem, strict quality control and quality inspection has been carried out in the manufacturing process of the imaging optical system so that the entry of dust or the occurrence of a scratch causing such a problem should be avoided. However, this requires control of dusts and scratches on the order of microns, which causes a problem of an increase in the production cost. Further, in a single-lens reflex DSC or the like that allows an operator to replace its imaging optical system, dust possibly could enter when the imaging optical system is replaced. Therefore, it is necessary to carry out cumbersome cleaning frequently, which is irksome.

Then, a DSC configured so that dust adhering to an optical surface of an imaging element is removed by rapidly vibrating the imaging element has been brought to market (see, for instance, JP 2003-319222 A, JP 2003-348401 A, and JP 2003-348462 A).

### DISCLOSURE OF INVENTION

### Problem to be Solved by the Invention

However, the above-described DSC configured so that dust is removed by rapidly vibrating an imaging element has a disadvantage in that its effect is limited to an optical surface of the imaging element. Further, this mechanism has a disadvantage in that a scratch, strongly adhering dust, etc. cannot be removed. Still further, since it is necessary to provide a driving device exclusively for removal of dust, there arises a problem of an increase in the cost, and moreover, a problem of an increase in the size.

The present invention has been made in light of the above-described problems, and it is an object of the present invention to provide an imaging optical instrument, a captured image processing system, and a captured image processing program that are capable of preventing the image quality of a captured image from being deteriorated by dust or a scratch in an imaging optical system.

### Means for Solving Problem

In order to achieve the above described object, an imaging optical instrument of the present invention includes: an imaging optical system; an imaging element for converting a subject image formed by the imaging optical system into image data; an image shift unit for working on at least one of the imaging optical system and the imaging element so as to shift a position of the subject image with respect to the imaging element; an image storage unit for storing a plurality of sets of image data concerning the subject image at different positions, respectively, the subject image having been captured while the position of the subject image was being shifted by the image shift unit; and a harmful luminance image detection unit. The harmful luminance detection unit includes: an image shift arithmetic unit for carrying out arithmetic processing with respect to the plurality of sets of image data so that the positions of the subject image of the plurality of sets of image data coincide with one another; and a differential image arithmetic unit for carrying out differential arithmetic processing with respect to the sets of image data with the positions of the subject image having been made to coincide with one another, so as to detect sets of harmful luminance image data in relation to the plurality of sets of image data, respectively, and further, detecting a set of harmful luminance image data corresponding to any one of the sets of image data, from the sets of the harmful luminance image data in relation to the plurality of sets of image data.

Further, a captured image processing system of the present invention includes an imaging optical instrument and a control device. The image optical instrument includes: an imaging optical system; an imaging element for converting a subject image formed by the imaging optical system into image data; an image shift unit for working on at least one of the imaging optical system and the imaging element so as to shift a position of the subject image with respect to the imaging element; and an image storage unit for storing a plurality of sets of image data concerning the subject image at different positions, respectively, the subject image having been captured while the position of the subject image was being shifted by the image shift unit. The control device includes a harmful luminance image detection unit and an image correction unit. The harmful luminance image detection unit includes: an image shift arithmetic unit for carrying out arithmetic processing with respect to the plurality of sets of image data so that the positions of the subject image of the plurality of sets of image data coincide with one another; and a differential image arithmetic unit for carrying out differential arithmetic processing with respect to the sets of image data with the positions of the subject image having been made to coincide with one another, so as to detect sets of harmful luminance image data in relation to the plurality of sets of image data, respectively, and further, detecting a set of harmful luminance image data corresponding to any one of the sets of image data, from the sets of harmful luminance image data in relation to the plurality of sets of image data. The image correction unit is for, by using the detected set of harmful luminance image data corresponding to the one of the sets of image data, correcting the image data corresponding to the detected set of harmful luminance image data, so as to obtain a correction-completed image.

A captured image processing program of the present invention allows a computer to execute: input processing for inputting a plurality of sets of image data concerning a subject image at different positions, respectively; image shift processing for carrying out arithmetic processing with respect to the plurality of sets of image data so that the positions of the subject image of the plurality of sets of image data coincide with one another; differential processing for carrying out differential arithmetic processing with respect to the plurality of sets of image data having been subjected to the image shift processing; harmful luminance image data detection processing for detecting a set of harmful luminance image data corresponding to any one of the sets of image data, from the sets of the harmful luminance image data in relation to the plurality of sets of image data, respectively, which have been detected through the differential processing; and image correction processing for, by using the detected set of harmful luminance image data corresponding to the one of the sets of image data, correcting the image data corresponding to the detected set of harmful luminance image data.

### EFFECTS OF THE INVENTION

With the present invention, it is possible to prevent the image quality of a captured image from being deteriorated by dust or a scratch in the imaging optical system.

### BRIEF DESCRIPTION OF DRAWINGS

FIG. 1 is a block diagram illustrating an example of a configuration of an imaging optical instrument according to Embodiment 1 of the present invention.

FIG. 2A is a drawing for illustrating a shift of a position of a subject image caused by driving an image shift unit, according to Embodiment 1 of the present invention, and illustrates a state in which the subject image is formed at a desired position on the imaging element.

FIG. 2B is a drawing for illustrating a shift of a position of a subject image caused by driving an image shift unit, according to Embodiment 1 of the present invention, and illustrates a state in which the subject image is shifted.

FIG. 3A illustrates a first image obtained by driving the image shift unit, according to an embodiment of the present invention.

FIG. 3B illustrates a second image obtained by driving the image shift unit, according to an embodiment of the present invention.

FIG. 4 illustrates a state in which images are superimposed so that the subject images coincide with each other, according to an embodiment of the present invention.

FIG. 5 illustrates a state after the respective images are subjected to differential arithmetic processing, according to Embodiment 1 of the present invention.

FIG. 6 is a graph showing the relationship between a luminance signal intensity of harmful luminance image data and a position in the Y direction, according to Embodiment 1 of the present invention.

FIG. 7 illustrates an image having a harmful luminance image corresponding to the first image, according to Embodiment 1 of the present invention.

FIG. 8 illustrates a correction-completed image according to an embodiment of the present invention.

FIG. 9 is a block diagram illustrating an example of a configuration of a capturing image processing system according to Embodiment 2 of the present invention.

FIG. 10 is a flowchart showing an operation of a control device according to Embodiment 2 of the present invention.

FIG. 11 is a perspective view illustrating a configuration of an imaging optical instrument according to Embodiment 2 of the present invention.

FIG. 12 is an exploded perspective view illustrating a configuration of another imaging optical instrument according to Embodiment 2 of the present invention.

FIG. 13 is a perspective view illustrating a specific configuration of a captured image processing system according to Embodiment 2 of the present invention.

FIG. 14 is a block diagram illustrating an example of a configuration of a first conventional imaging optical instrument.

FIG. 15 is a block diagram illustrating an example of a configuration of a second conventional imaging optical instrument.

FIG. 16 is a block diagram illustrating an example of a configuration of a third conventional imaging optical instrument.

### DESCRIPTION OF THE INVENTION

With the imaging optical instrument of the present invention, it is possible to obtain a captured image from which a harmful luminance image is removed without removing dust or a scratch in the imaging optical system that causes the harmful luminance image data to be generated. As a result, it is possible to prevent the image quality of a captured image from being deteriorated due to dust or a scratch in the imaging optical system.

The imaging optical instrument of the present invention preferably further includes an image correction unit for, by using the detected set of harmful luminance image data corresponding to the one of the sets of image data, correcting the image data corresponding to the detected set of harmful luminance image data, so as to obtain a correction-completed image.

Further, the imaging optical instrument of the present invention preferably further includes a movement detection unit for detecting a movement of a main body of the imaging optical instrument, wherein based on the movement data fed from the movement detection unit, a shift of the position of the subject image with respect to the imaging element caused by the movement of the main body of the imaging optical instrument is corrected by the image shift unit. This configuration provides the imaging optical instrument with the camera shake correction function.

Still further, the imaging optical instrument of the present invention preferably further includes a warning unit for issuing a warning according to an intensity of the harmful luminance image data. This configuration allows an operator to check the necessity and timing of lens cleaning and the like. In the case where much dust adheres to the inside of the imaging optical system, the foregoing configuration is capable of suggesting that the operator clean the inside of the imaging optical system.

Still further, the imaging optical instrument of the present invention preferably further includes a harmful luminance image storage unit for storing the harmful luminance image data. This configuration allows the operator to check the degree of a harmful luminance image that has been corrected.

Still further, the captured image processing system of the present invention may be configured by using a control device having high arithmetic processing performance. Therefore, the imaging optical instrument is not required to perform a great amount of arithmetic processing. Consequently, the lifetime of a power supply of the imaging optical instrument can be extended.

Still further, the captured image processing system of the present invention preferably is configured so that the imaging optical instrument further includes a movement detection unit for detecting a movement of a main body of the imaging optical instrument, wherein based on the movement data fed from the movement detection unit, a shift of the position of the subject image with respect to the imaging element caused by the movement of the main body of the imaging optical instrument is corrected by the image shift unit. This configuration provides the imaging optical instrument with the camera shake correction function.

Still further, the captured image processing system of the present invention preferably further includes a warning unit for issuing a warning according to an intensity of the harmful luminance image data. This configuration allows an operator to check the necessity and timing of lens cleaning and the like. In the case where much dust adheres to the inside of the imaging optical system, the foregoing configuration is capable of suggesting that the operator clean the inside of the imaging optical system.

Still further, the captured image processing system of the present invention preferably further includes a harmful luminance image storage unit for storing the harmful luminance image data. This configuration allows the operator to check the degree of a harmful luminance image that has been corrected.

Still further, by executing the captured image processing program of the present invention, the image quality of a captured image can be prevented easily from being deteriorated due to dust or a scratch in the imaging optical system.

The following describes specific embodiments of the present invention while referring to the drawings.

### EMBODIMENT 1

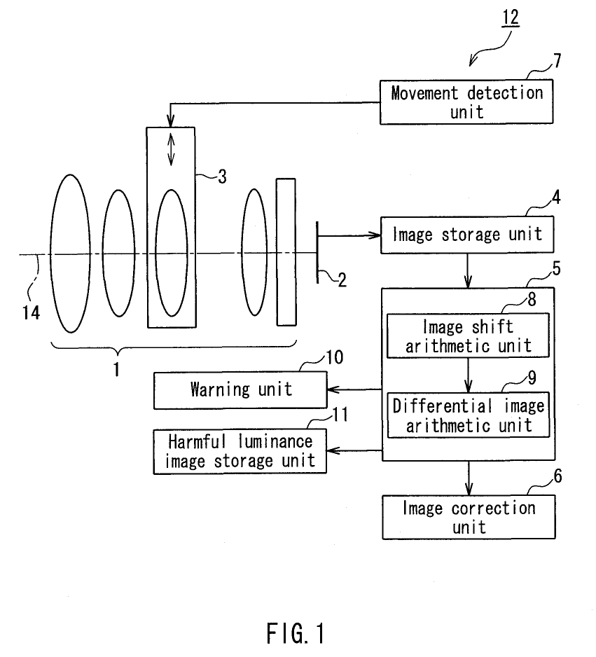

The following describes an imaging optical instrument according to Embodiment 1 of the present invention while referring to the drawings. FIG. 1 is a block diagram illustrating an example of a configuration of an imaging optical instrument according to Embodiment 1 of the present invention.

As shown in FIG. 1, an imaging optical instrument 12 according to Embodiment 1 includes an imaging optical system 1, an imaging element 2, an image shift unit 3, an image storage unit 4, a harmful luminance image detection unit 5, an image correction unit 6, a movement detection unit 7, a warning unit 10, and a harmful luminance image storage unit 11. Further, the harmful luminance image detection unit 5 includes an image shift arithmetic unit 8 and a differential image arithmetic unit 9.

The following describes an operation of the imaging optical instrument 12.

First, light from a subject enters the imaging optical system 1 along an imaging optical axis 14. The imaging optical system 1 has lenses so as to form a subject image on a light receiving surface of the imaging element 2. The imaging element 2 generates digital image data according to a subject image, and causes the image storage unit 4 such as a medium or an internal memory to store the image data. The image data contain, for instance, a luminance signal, etc.

The image shift unit 3 is capable of working on the imaging optical system 1 so as to shift a subject image formed on the imaging element 2 in a direction substantially perpendicular to the imaging optical axis 14. More specifically, the image shift unit 3 is capable of decentering at least one lens of the imaging optical system 1 in a direction substantially perpendicular to the imaging optical axis 14 of the imaging optical system 1, thereby shifting the subject image on the light receiving surface of the imaging element 2 in a direction substantially perpendicular to the imaging optical axis 14.

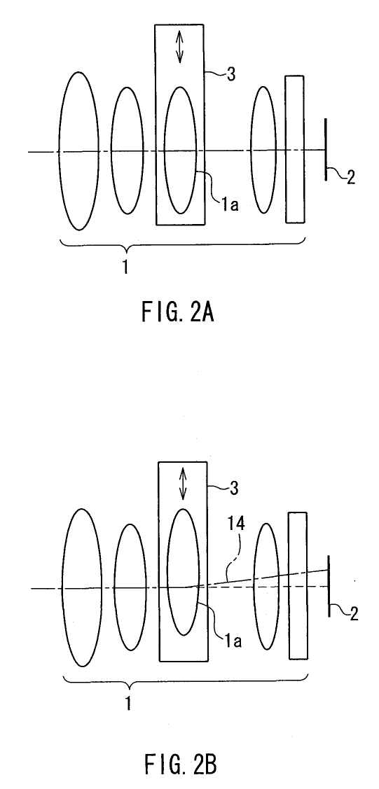

When the subject is imaged, the imaging optical instrument 12 causes the image shift unit 3 to obtain a plurality of sets of image data, which are obtained by shifting the subject image in the direction substantially perpendicular to the imaging optical axis 14. In other words, the imaging optical instrument 12 obtains a plurality of sets of image data concerning subject images, respectively, which are shifted from one to another in a direction along the light receiving surface of the imaging element 2. FIGS. 2A and 2B are drawings for illustrating the shift of the subject image caused by driving the image shift unit 3. FIG. 2A illustrates a state in which the subject image is formed at a desired position on the imaging element, and FIG. 2B illustrates a state in which the subject image is shifted. As shown in FIG. 2A, in the case where a lens 1a of the imaging optical system 1 is positioned at a normal position, the subject image is formed at center of the imaging element 2. However, as shown in FIG. 2B, when the lens 1a is shifted in a direction substantially perpendicular to the imaging optical axis 14 (for instance, upward), the imaging optical axis 14 is shifted upward, for instance, whereby the subject image is formed on an upper part of the imaging element 2.

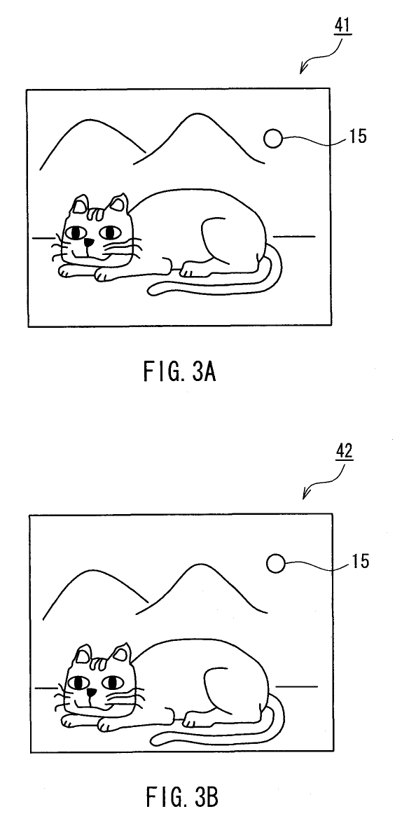

Further, the following describes an image in the case where the subject image is shifted along the light receiving surface of the imaging element 2, while referring to FIGS. 3A and 3B. FIGS. 3A and 3B illustrate images obtained by driving the image shift unit. FIG. 3A illustrates a first image, and FIG. 3B illustrates a second image. The image shown in FIG. 3A is an image (first image 41) according to image data of the state shown in FIG. 2A, i.e., the state in which the subject image is formed at the desired position on the imaging element. The image shown in FIG. 3B is an image (second image 42) according to image data of the state shown in FIG. 2B, i.e., the state in which the subject image has been shifted. The reason why the second image 42 shown in FIG. 3B is shifted downward as compared with the first image 41 shown in FIG. 3A is that the imaging optical axis 14 is shifted upward. It should be noted that since the subject image is an image inverted vertically and horizontally, in the case where the imaging optical axis 14 is shifted upward, the image is shifted downward.

Thus, by shifting the path of the subject light entering the imaging optical system 1 along the imaging optical axis 14, images are captured in respective states. More specifically, in the state shown in FIG. 2A, the image data of the first image 41 shown in FIG. 3A are captured. Subsequently, the image data of the second image 42 shown in FIG. 3B are captured in the state shown in FIG. 2B in which the light from a subject entering the imaging optical system 1 along the imaging optical axis 14 is shifted upward. Since the imaging process for capturing these two sets of image data can be carried out within an extremely short time, the capturing of the two sets of image data can be carried out easily without any problem, as for a normal subject.

As shown in FIGS. 3A and 3B, comparing the first image 41 and the second image 42, the respective positions of the subject image are shifted from each other. However, a harmful luminance image 15 occurring due to dust or a scratch in the imaging optical system 1 is not shifted, unlike the subject image. In the case where the dust or the scratch causing the harmful luminance image 15 is positioned in the vicinity of the imaging element 2 and is closer to the imaging element 2 than to the lens 1a shifted by the image shift unit 3, the position of the harmful luminance image 15 with respect to the imaging element 2 does not change. Therefore, in the first image 14 and the second image 42, the respective relative positions of the harmful luminance image 15 with respect to the subject image are different.

It should be noted that besides the harmful luminance image 15, a random noise component due to dark current or the like, a component due to a slight aberration change and an angle-of-view component contained in only one of the images appear at different relative positions in the first and second images 41 and 42.

The image data of the first image 41 (hereinafter referred to as “first image data”) and the image data of the second image 42 (hereinafter referred to as “second image data”) formed in the imaging element 2 are stored in the image storage unit 4 and are transferred to the harmful luminance image detection unit 5. The harmful luminance image detection unit 5 detects the harmful luminance image data as the image data of the harmful luminance image 15, by referring to the first image data and the second image data. The method for detecting the same is described below.

The harmful luminance image detection unit 5 includes an image shift arithmetic unit 8 for making the position of the subject image according to the first image data and the position of the subject image according to the second image data coincide with each other, and a differential image arithmetic unit 9 for carrying out differential arithmetic processing with respect to the first image data and the second image data. First, the first image data and the second image data, which are stored data of images of a subject with a shift therebetween, are subjected to arithmetic processing by the image shift arithmetic unit 8 so that their respective subject images are substantially superimposed on each other to coincide with each other. More specifically, the second image data are subjected to arithmetic processing so that pixels of the second image 42 are shifted upward. This makes it possible to extract image data that do not coincide with each other from the first image data and the second image data. Next, the first image data and the second image data are subjected to differential arithmetic processing by the differential image arithmetic unit 9. This allows components of the subject images commonly present in the first image data and the second image data to be removed, whereby harmful luminance image data of the first and second image data are detected. From the respective harmful luminance image data of these images, harmful luminance image data corresponding to only either the first image data or the second image data (for instance, the first image data) are detected.

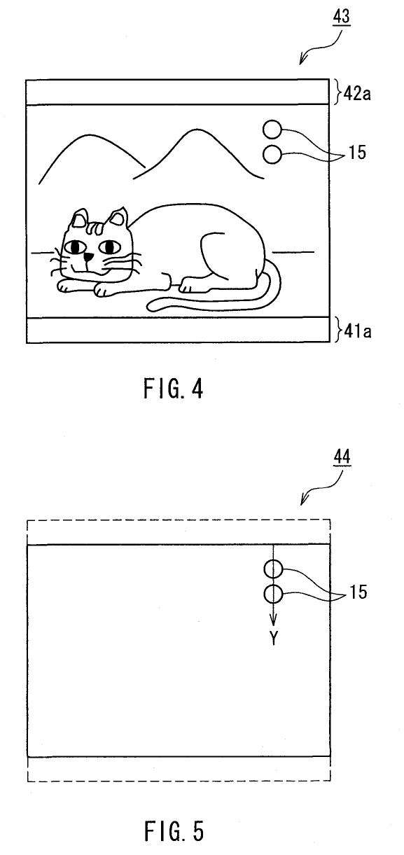

The following describes the above-described process more specifically by using images. FIG. 4 illustrates a state in which images are superimposed so that the subject images coincide with each other. The first image 41 and the second image 42, whose subject image positions are made to coincide with each other by the image shift arithmetic unit 8, are superimposed, whereby an image 43 is obtained. In the image 43 shown in FIG. 4, the respective harmful luminance images 15 do not fall on each other but are formed at different positions. It should be noted that angle-of-view portions that cannot be superimposed are present in both sets of the image data. More specifically, a lower end portion 41a of the first image 41 and an upper end portion 42a of the second image 42 are angle-of-view portions. Harmful luminance image data cannot be obtained from these portions, and hence these portions are not used in the arithmetic processing.

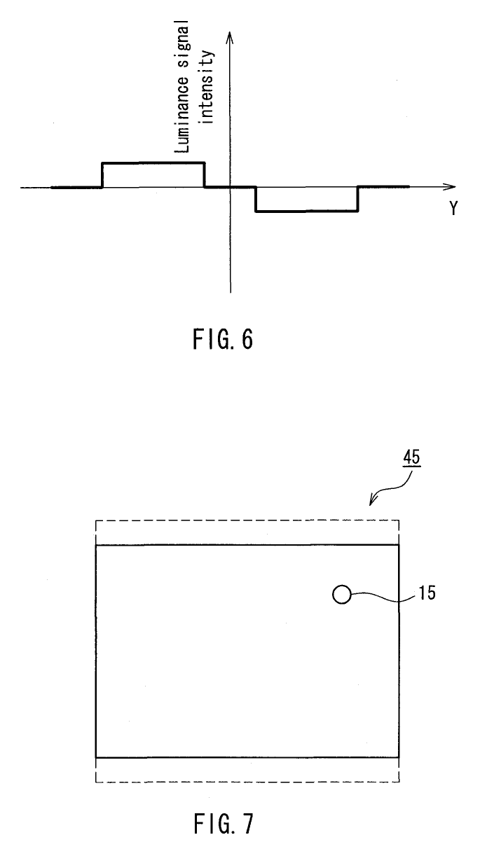

FIG. 5 illustrates a state after the respective images are subjected to differential arithmetic processing. The first image data and the second image data after having been subjected to the image shift arithmetic processing are subjected to differential arithmetic processing by the differential image arithmetic unit 9, whereby an image 44 after differential arithmetic processing (hereinafter referred to as post-differential arithmetic processing image 44) is obtained. As shown in FIG. 5, the post-differential arithmetic processing image 44 contains two harmful luminance images 15. The graph in FIG. 6 shows the relationship between a luminance signal intensity of image data (harmful luminance image data) of the harmful luminance image 15 and a position in the Y direction shown in FIG. 5, in which the luminance signal intensity is plotted in the vertical axis while the position in the Y direction is plotted in the horizontal axis. It should be noted that the Y direction is the vertical direction, as shown in FIG. 5. As shown in FIG. 6, the luminance signal of the harmful luminance image data is divided into two parts having positive and negative intensities, respectively. In order to making them into one, image processing including processing by a low pass filter (LPF), etc., is performed preferably. By performing image processing including that by the LPF, etc., the random noise component due to dark current or the like and the component due to a slight aberration change, which are contained in the image data of the post-differential arithmetic processing image 44, are removed also. It should be noted that in the case where image data from which such a random noise component and a component due to an aberration change are not removed are used in a subsequent step of correction, the noise is increased and image forming performance are deteriorated.

By performing image processing including that by LPF, etc., an image 45 having a harmful luminance image 15 corresponding to the first image 41 can be obtained, as shown in FIG. 7. Thus, image data of the harmful luminance image 15 can be extracted easily.

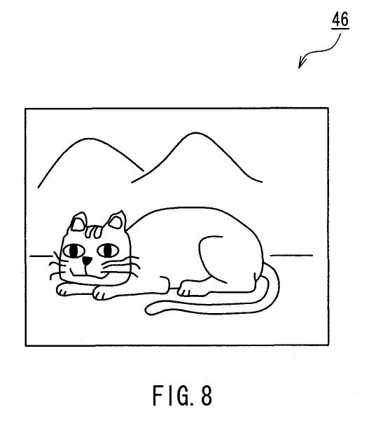

Next, by using harmful luminance image data formed through the above-described image processing including that by LPF, the first image data are corrected. More specifically, the image correction unit 6 may use the first image data and the harmful luminance image data so as to remove the harmful luminance image data from the first image data. By so doing, the harmful luminance image data are removed, whereby image data of a correction-completed image, correction of which has been completed, are obtained. FIG. 8 illustrates the correction-completed image. The correction-completed image 46 does not contain a harmful luminance image, and is composed of only the subject image. In other words, by removing the harmful luminance image 15 of the image 45 shown in FIG. 7 from the first image 41 shown in FIG. 3A, the correction-completed image 46 shown in FIG. 8 can be obtained. It should be noted that an image to be corrected may be the second image 42 instead of the first image 41, or a composite image of the first and second images 41 and 42. In such a case, a corresponding harmful luminance image accordingly may be used. However, it is most preferable to use the first image 41 with the shorter release time lag. Here, the release time lag refers to a time from an image capturing action (for instance, an action of pressing the release button, etc.) till an instance of actually capturing the image when a subject is imaged with use of the imaging optical instrument 12, and the shorter the release time lag is, the better the captured image that can be obtained.

As described above, the imaging optical instrument 12 of Embodiment 1 makes it possible to obtain an image from which a harmful luminance image 15 due to dust in the imaging optical system 1, a scratch on the imaging optical system 1, or the like can be removed, thereby improving the image quality of captured images. Therefore, with the imaging optical instrument 12 of Embodiment 1, it is possible to remove the harmful luminance image 15 by correction, without removing causes of the harmful luminance image 15, such as dust in the imaging optical system 1 or a scratch on the imaging optical system 1. Therefore, even in the case where dust has gotten in the imaging optical system 1, for instance, deterioration of the image quality of a captured image can be prevented, without cleaning the inside of the imaging optical system 1. Therefore, it is not necessary to carry out cleaning immediately, and may be carried out, for example, when the operator has spare time.

Further, the harmful luminance image data are stored in the harmful luminance image storage unit 11. This allows the operator to check the degree of a harmful luminance image that has been corrected, and this allows the operator to, for example, check whether or not the problem of the harmful luminance image is solved after cleaning, and the like.

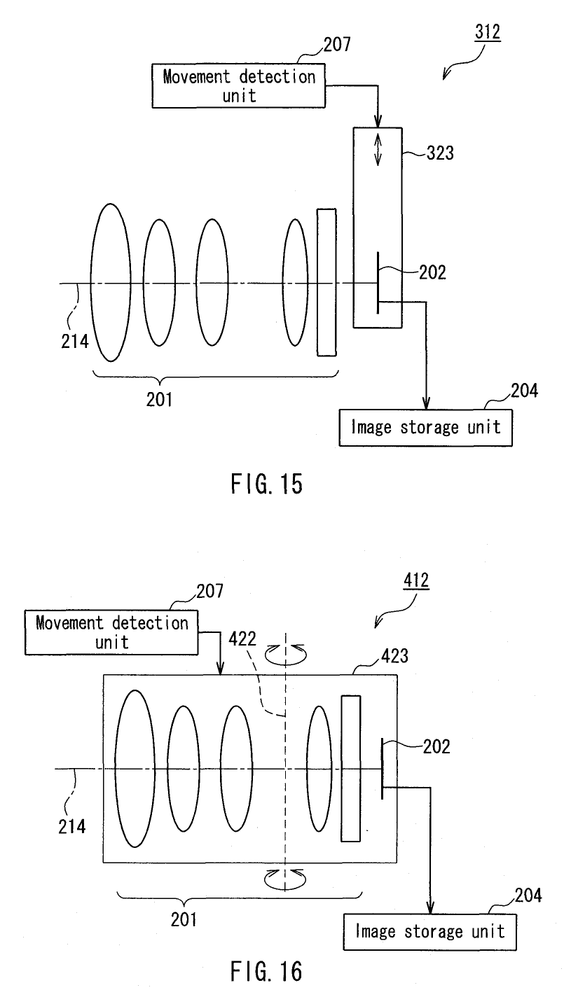

Further, the imaging optical instrument 12 of Embodiment 1 includes a movement detection unit 7 for detecting a movement of the main body of the imaging optical instrument 12. The movement detection unit 7 is intended to detect an amount of camera shake occurring when the operator operates the imaging optical instrument 12, and is capable of detecting a direction and an amount of movement, etc., of the imaging optical instrument 12. The movement detection unit 7 preferably is an angular velocity sensor such as a gyro sensor, for example. The camera shake is corrected according to movement information detected by the movement detection unit 7. The camera shake correction may be performed by using the image shift unit 3, and a shift of a position of the subject image with respect to the imaging element 2 due to camera shake may be corrected by the image shift unit 3 so that the subject image should not be blurred. By so doing, camera shake is corrected, and an excellent image can be obtained. It should be noted that a conventional configuration may be used as the movement detection unit 7. Further, as the image shift unit 3, the movement correction unit used in the first to third conventional image optical instruments shown in FIGS. 14 to 16 may be used, for example. More specifically, a configuration capable of shifting the subject image in a direction substantially perpendicular to the imaging optical axis by either decentering the imaging optical system or the imaging element or rotating the imaging optical system or the imaging element may be used as the image shift unit 3. In Embodiment 1, the image shift unit 3 also functions as the movement correction unit, which has been provided in the conventional imaging optical instrument. With this configuration, the imaging optical instrument 12 capable of correcting camera shake and harmful luminance images can be obtained without providing an additional mechanism.

Further, the imaging optical instrument 12 includes a warning unit 10. When the luminance signal intensity of a harmful luminance image detected by the harmful luminance image detection unit 5 is at a predetermined level or above, the warning unit 10 alerts the operator to it. For instance, the differential image arithmetic unit 9 evaluates the luminance signal intensity data of a harmful luminance image detected, and in the case where the value thereof is at the predetermined level or above, the differential image arithmetic unit 9 conveys the information to the warning unit 10. In response to it, the warning unit 10 issues a noticeable warning to the operator. As the warning unit 10, a configuration using a LCD (liquid crystal display), for instance, for displaying the warning may be used. Alternatively, a configuration displaying the warning in a display of a viewfinder so that it can be recognized visually may be used. This allows the operator to check the necessity of lens cleaning or the timing of the same. Further, in the case where much dust adheres to the inside of the imaging optical system 1, the foregoing configuration is capable of suggesting that the operator clean the inside of the imaging optical system 1. It should be noted that the warning preferably is carried out before the correction-completed image 46 is obtained.

It should be noted that in Embodiment 1 the operation of the image correction unit 6 is performed automatically, but prior to the operation of the image correction unit 6, the user may be asked to make the decision regarding whether or not image correction should be carried out, so that the user's intention should be reflected on the decision. Alternatively, the image correction unit 6 may be configured to have a mode for performing the image correction and a mode for not performing the image correction, and the user may be allowed to operate the image correction unit 6 selectively. Such a configuration increases the convenience of the user.

Further, the harmful luminance image stored in the harmful luminance image storage unit 11 may be allowed to be stored in association with the subject image prior to the processing by the image correction unit 6, and to be outputted to the outside from the harmful luminance image storage unit 11. Such a configuration makes it possible to perform the removal of a harmful luminance image in a post-processing step with use of a personal computer or the like. A harmful luminance image to be associated with the subject image prior to the processing by the image correction unit 6 may be image data themselves, or alternatively, position data of pixels corresponding to the range occupied by the harmful luminance image.

Still further, in Embodiment 1, the warning unit 10 is operated in the case where a harmful luminance image has a luminance signal intensity at a predetermined level or above, but instead of operating the warning unit 10, an operation of the imaging optical system for capturing the subject image may be inhibited. Such a configuration makes it possible to prevent the generation of image data with low image quality due to a high luminance signal intensity of a harmful luminance image.

### EMBODIMENT 2

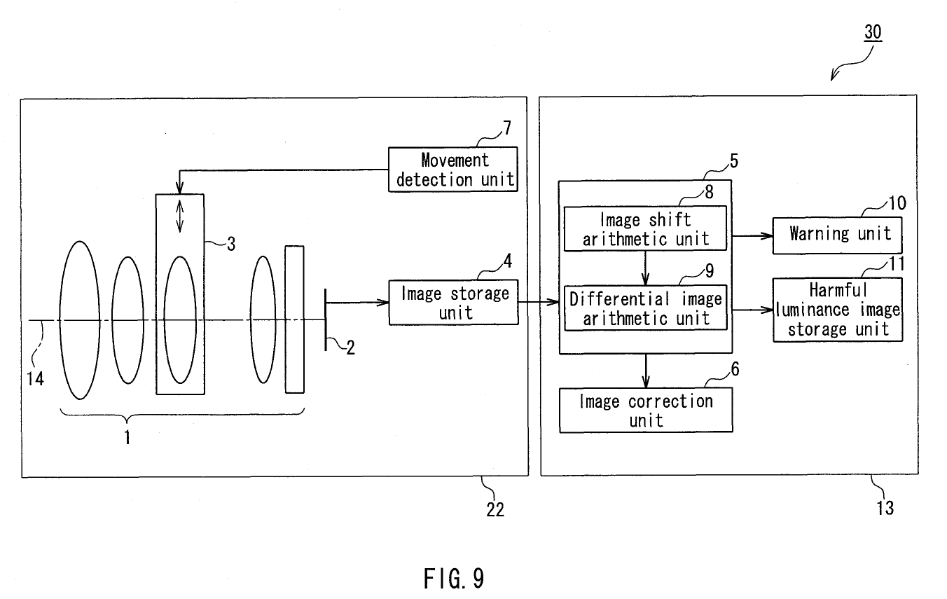

The following describes a capturing image processing system according to Embodiment 2 of the present invention while referring to the drawings. FIG. 9 is a block diagram illustrating an example of a configuration of the capturing image processing system according to Embodiment 2 of the present invention. It should be noted that in FIG. 9 members having the same functions as those of the members shown in FIG. 1 are designated with the same reference numerals, and descriptions of the same are omitted.

As shown in FIG. 9, a captured image processing system 30 according to Embodiment 2 includes an imaging optical instrument 22 for capturing an image, and a control device 13 for subjecting the image captured by the imaging optical instrument 22 to image processing so as to correct the harmful luminance image. The imaging optical instrument 22 includes an imaging optical system 1, an imaging element 2, an image shift unit 3, a movement detection unit 7, and an image storage unit 4. The control device 13 includes a harmful luminance image detection unit 5, an image correction unit 6, a warning unit 10, and a harmful luminance image storage unit 11. Further, the harmful luminance image detection unit 5 includes an image shift arithmetic unit 8 and a differential image arithmetic unit 9.

A personal computer, for instance, may be used as the control device 13. In this case, the functions of the harmful luminance image detection unit 5 and the image correction unit 6 in the control device 13 are implemented by a CPU of the personal computer executing a predetermined program. To do so, specifically, a program for implementing the functions of the harmful luminance image detection unit 5 and the image correction unit 6 may be installed in an arbitrary personal computer. For instance, the program may be installed from a storage medium such as a CD-ROM to an arbitrary personal computer, or may be installed in an arbitrary computer by downloading it via a communication line, etc. As the warning unit 10, for example, an audio output unit such as a speaker connected with the personal computer, or a display unit including a display may be used. Further, as the harmful luminance image storage unit 11, a hard disk of the personal computer may be used.

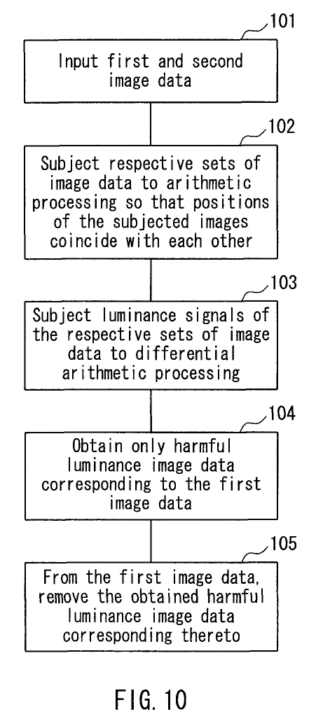

Next, an operation of the captured image processing system 30 according to Embodiment 2 is described by using FIG. 10 as well. FIG. 10 is a flowchart showing an operation of the control device 13 according to Embodiment 2 of the present invention.

Since the respective operations of the members of the imaging optical instrument 22, i.e., the operations of the imaging optical system 1, the imaging element 2, the image shift unit 3, the movement detection unit 7, and the image storage unit 4, are identical to the operations of the members of the imaging optical instrument 12 according to Embodiment 1, descriptions of the same are omitted. In the imaging processing by the imaging optical instrument 22, the first image 41 and the second image 42 shown in FIGS. 3A and 3B are captured. The first image data and the second image data, which are image data of the first image 41 and the second image 42, are stored in the image storage unit 4.

The first image data and the second image data are transferred to the control device 13, and these data are fed to the harmful luminance image detection unit 5 (Step 101).

Next, the first and second image data are subjected to arithmetic processing by the image shift arithmetic unit 8 in the harmful luminance image detection unit 5 so that the respective subject images of the first image data and the second image data substantially are superimposed on each other to coincide with each other (Step 102). It should be noted that angle-of-view portions that cannot be superimposed are present in both sets of the image data. More specifically, a lower end portion 41a of the first image 41 and an upper end portion 42a of the second image 42 are angle-of-view portions. Harmful luminance image data cannot be obtained from these portions, and hence these portions are not used in the arithmetic processing (see FIG. 4).

Next, the first image data and the second image data having been subjected to Step 102 (image shift arithmetic processing) are subjected to differential arithmetic processing by using the differential image arithmetic unit 9 (Step 103). The resultant harmful luminance image data are related to both of the first image data and the second image data, thereby having two luminance signal intensities of a positive one and a negative one. Then, these data are subjected to further image processing, for instance, image processing including processing by a LPF, etc. (Step 104). By so doing, harmful luminance image data corresponding to either the first image data or the second image data are obtained. Here performed is image processing such that only harmful luminance image data corresponding to first image data are obtained.

Next, the first image data and the harmful luminance image data obtained at Step 104 corresponding to the first image data are transferred to the image correction unit 6. Using the first image data and the harmful luminance image data corresponding to the same, the image correction unit 6 removes the harmful luminance image data from the first image data (Step 105). As a result, the correction-completed image 46 from which the harmful luminance image 15 is removed (see FIG. 8) is obtained.

It should be noted that the harmful luminance image detection unit 5 determines the intensity of the luminance signal of the harmful luminance image data obtained at Step 104, and in the case where the intensity is at a predetermined level or above, a signal informing the same is transmitted to the warning unit 10. The warning unit 10 issues a warning in response to the same. For instance, an audible alarm may be sounded by a speaker as the warning unit 10, or a visible warning may be shown on a display as the warning unit 10. It should be noted that the warning preferably is issued before the correction-completed image 46 is obtained.

Further, the harmful luminance image storage unit 11 stores the harmful luminance image data obtained at Step 104. This makes it possible to check the degree of a harmful luminance image that occurs with the captured image.

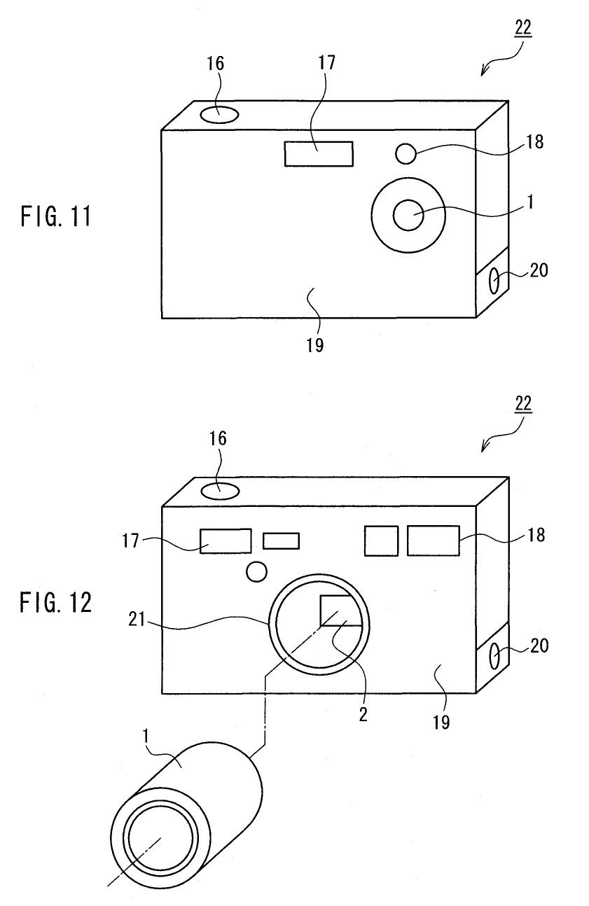

Next, a specific configuration of the imaging optical instrument 22 according to Embodiment 2 is described with reference to the drawings. FIG. 11 is a perspective view illustrating a configuration of an imaging optical instrument according to Embodiment 2 of the present invention. FIG. 11 illustrates a configuration of a compact-type DSC as the imaging optical instrument 22.

In FIG. 11, the imaging optical instrument 22 includes an imaging optical system 1, a release button 16, a strobe light flashing unit 17, an optical viewfinder 18, a main body 19, and a digital image data output connector 20.

The imaging optical system 1 is intended to form a subject image. The release button 16 is a button that an operator presses to capture a subject image. By pressing the release button 16 down, an image of a subject is captured. The strobe light flashing unit 17 is capable of emitting light in the case where the luminance of a subject is insufficient, so that the light illuminates the subject and a luminance sufficient for capturing an image of the subject can be obtained. The optical viewfinder 18 is intended to allow the operator to check the composition of the subject. The main body 19 is intended to allow the operator to hold the imaging optical instrument 22. The data output connector 20 is intended to output the captured and stored image data to the outside of the imaging optical instrument 22.

Further, FIG. 12 is an exploded perspective view illustrating a configuration of another imaging optical instrument according to Embodiment 2 of the present invention. In FIG. 12, the members having the same functions as those of the members shown in FIG. 11 are designated with the same reference numerals, and descriptions of the same are omitted. The imaging optical instrument 22 shown in FIG. 12 is configured so that the imaging optical system 1, which is a lens, is detachable from the main body 19 so as to be replaced. FIG. 12 shows a state in which the imaging optical system 1 is detached from the main body 19. For use, the imaging optical system 1 is fitted in a lens mount 21 so as to be fixed. It should be noted that FIG. 12 shows the imaging element 2 disposed inside the imaging optical instrument 22. Thus, the imaging optical instrument 22 shown in FIG. 12 is configured so that the imaging optical system 1 is detachable from the main body 19. With this configuration, as described above, when there is a warning that a luminance signal of image data of a harmful luminance image occurring due to dust or a scratch in the image optical system 1 is at an excessive level, the imaging optical system 1 may be replaced, whereby the cause of the harmful luminance image can be removed easily.

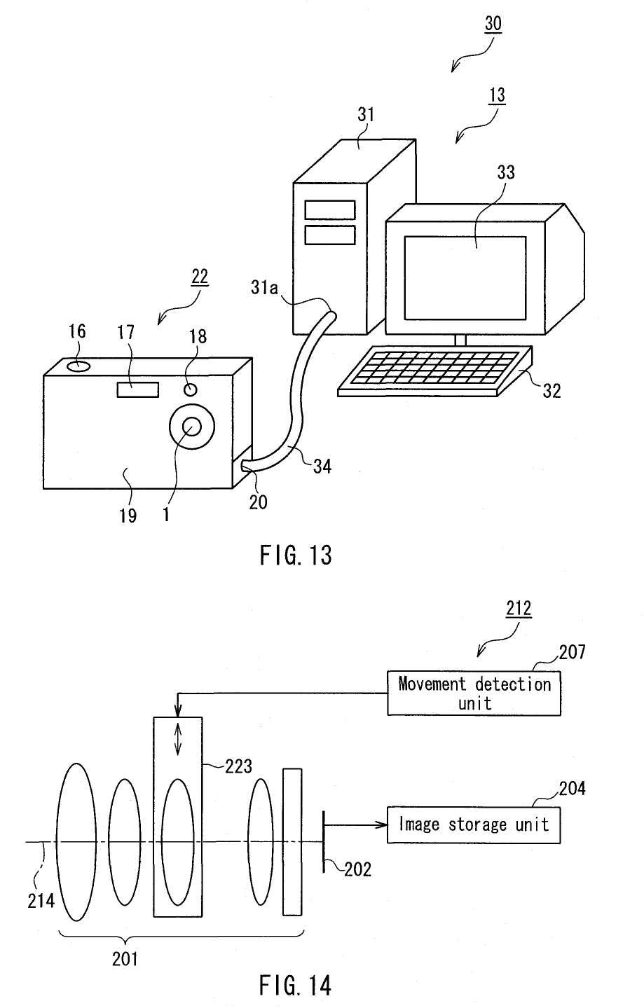

Next, a specific configuration of a captured image processing system 30 according to Embodiment 2 is described with reference to the drawings. FIG. 13 is a perspective view illustrating a specific configuration of a captured image processing system according to Embodiment 2 of the present invention.

As shown in FIG. 13, the captured image processing system 30 includes an imaging optical instrument 22 shown in FIG. 11 and a control device 13 that is a personal computer. It should be noted that a main body 31 of the control device 13 is connected with a keyboard 32 as an input device and a display 33 as a display unit.

A program for implementing the flowchart shown in FIG. 10 is installed in the control device 13. The imaging optical instrument 22 and the control device 13 are connected via a cable 34, for instance, so that signals can be inputted/outputted. This makes it possible to transmit image data from the imaging optical instrument 22 to the control device 13. More specifically, a data output connector 20 of the imaging optical instrument 22 and a data input connector 31a provided in the main body 31 of the control device 13 are connected with each other via the cable 34.

As described above, the captured image processing system 30 according to Embodiment 2 allows image data captured by the imaging optical instrument 22 to be subjected to arithmetic processing by the control device 13. This makes it unnecessary to perform a great amount of arithmetic processing in the imaging optical instrument 22. Consequently, the lifetime of a power supply of the imaging optical instrument 22 can be extended.

Further, in the case where such an imaging optical instrument 22 of the captured image processing system 30 is used in an industrial production facility in an environment such that a foreign matter such as dust tends to adhere to the inside of the imaging optical system 1, even if the inside of the imaging optical system 1 is soiled, it is possible to obtain a corrected image of high quality. Further, it is possible to determine easily that a foreign matter such as dust adheres to the inside of the imaging optical system 1. Therefore, the production cost can be reduced considerably.

### INDUSTRIAL APPLICABILITY

With the imaging optical instrument, the captured image processing system, and the captured image processing program of the present invention, it is possible to provide a DVC or a DSC, or an imaging unit in portable mobile equipment that is capable of obtaining an excellent image in which a harmful luminance image due to dust or the like is corrected. They are advantageous particularly when being used in an industrial production facility or the like in an environment such that a foreign matter such as dust tends to adhere to the inside of the imaging optical system.

1. An image optical instrument comprising:
an imaging optical system;
an imaging element for converting a subject image formed by the imaging optical system into image data;
an image shift unit for working on at least one of the imaging optical system and the imaging element so as to vary the subject image with respect to the imaging element;
an image storage unit for storing a plurality of sets of image data, the sets of image data being data of variations of the subject image, respectively, that have been captured while being varied by the image shift unit; and
a harmful luminance image detection unit including:
an image shift arithmetic unit for carrying out arithmetic processing with respect to the plurality of sets of image data; and
a differential image arithmetic unit for carrying out differential arithmetic processing with respect to the plurality of sets of image data with, so as to detect sets of harmful luminance image data in relation to the plurality of sets of image data, respectively, and further, detecting a set of harmful luminance image data corresponding to any one of the sets of image data, from the sets of the harmful luminance image data in relation to the plurality of sets of image data.

2. The imaging optical instrument according to claim 1, further comprising:
an image correction unit for, by using the detected set of harmful luminance image data corresponding to the one of the sets of image data, correcting the image data corresponding to the detected set of harmful luminance image data, so as to obtain a correction-completed image.

3. The imaging optical instrument according to claim 1, further comprising:
a movement detection unit for detecting a movement of a main body of the imaging optical instrument,
wherein based on the movement data fed from the movement detection unit, a shift of the position of the subject image with respect to the imaging element caused by the movement of the main body of the imaging optical instrument is corrected by the image shift unit.

4. The imaging optical instrument according to claim 1, further comprising a warning unit for issuing a warning according to an intensity of the harmful luminance image data.

5. The imaging optical instrument according to claim 1, further comprising a harmful luminance image storage unit for storing the harmful luminance image data.

6. A captured image processing system comprising:
an imaging optical instrument including:
an imaging optical system;
an imaging element for converting a subject image formed by the imaging optical system into image data;
an image shift unit for working on at least one of the imaging optical system and the imaging element so as to vary the subject image with respect to the imaging element; and
an image storage unit for storing a plurality of sets of image data, the sets of image data being of variations of the subject image, respectively, that have been captured while being varied by the image shift unit; and,
a control device including:
a harmful luminance image detection unit including:
an image shift arithmetic unit for carrying out arithmetic processing with respect to the plurality of sets of image data; and
a differential image arithmetic unit for carrying out differential arithmetic processing with respect to the plurality of sets of image data, so as to detect sets of harmful luminance image data in relation to the plurality of sets of image data, respectively, and further, detecting a set of harmful luminance image data corresponding to any one of the sets of image data, from the sets of the harmful luminance image data in relation to the plurality of sets of image data; and
an image correction unit for, by using the detected set of harmful luminance image data corresponding to the one of the sets of image data, correcting the image data corresponding to the detected set of harmful luminance image data, so as to obtain a correction-completed image.

7. The captured image processing system according to claim 6, wherein the imaging optical instrument further includes a movement detection unit for detecting a movement of a main body of the imaging optical instrument,
wherein based on the movement data fed from the movement detection unit, a shift of the position of the subject image with respect to the imaging element caused by the movement of the main body of the imaging optical instrument is corrected by the image shift unit.

8. The captured image processing system according to claim 6, further comprising a warning unit for issuing a warning according to an intensity of the harmful luminance image data.

9. The captured image processing system according to claim 6, further comprising a harmful luminance image storage unit for storing the harmful luminance image data.

10. A captured image processing program for allowing a computer to execute:
input processing for inputting a plurality of sets of image data concerning a subject image at different positions, respectively;
image shift processing for carrying out arithmetic processing with respect to the plurality of sets of image data so that the positions of the subject image of the plurality of sets of image data coincide with one another;
differential processing for carrying out differential arithmetic processing with respect to the plurality of sets of image data having been subjected to the image shift processing;
harmful luminance image data detection processing for detecting a set of harmful luminance image data corresponding to any one of the sets of image data, from the sets of the harmful luminance image data in relation to the plurality of sets of image data, respectively, which have been detected through the differential processing; and image correction processing for, by using the detected set of harmful luminance image data corresponding to the one of the sets of image data, correcting the image data corresponding to the detected set of harmful luminance image data.
